(19) United States
(12) Patent Application Publication
(10) Pub. No.: US 2022/0341770 A1
(43) Pub. Date: Oct. 27, 2022

(54) PORTABLE VERIFICATION SYSTEM AND METHOD FOR USE IN LOWER PRESSURE COMMERCIAL AND RESIDENTIAL GAS FLOW METERS

(71) Applicant: Big Elk Energy Systems, LLC, Tulsa, OK (US)

(72) Inventor: Dennis McClintock, Tulsa, OK (US)

(21) Appl. No.: 17/740,196

(22) Filed: May 9, 2022

Related U.S. Application Data
(63) Continuation-in-part of application No. 16/610,973, filed on Nov. 5, 2019, now Pat. No. 11,326,928.
Application No. 16/610,973 is a continuation of application No. 15/588,630, filed on May 6, 2017, now Pat. No. 10,222,252.
(60) Provisional application No. 62/333,015, filed on May 6, 2016.
(60) Provisional application No. 63/328,066, filed on Apr. 6, 2022.

(51) Int. Cl. G01F 25/10

(52) U.S. Cl. CPC G01F 25/15; G01F 25/13; G01F 1/66

(57) ABSTRACT

Embodiments of a portable verification system can move from one commercial building or residential home gas flow meter location to another and temporarily connect to the building's or home's natural gas piping. The portable verification system may be connected to the gas flow meter by a flexible hose having a lap joint flange at one end. Adaptor fittings can be used to provide additional versatility. When in an intended use, natural gas flows into the reference meter and then into the gas flow meter connected to the commercial building or residential home. Downtime is limited to the time required to complete a circuit between the gas flow meter and the portable verification system.

### CROSS-REFERENCE TO CO-PENDING APPLICATIONS

This application claims priority to U.S. Ser. No. 63/328,066, filed Apr. 4, 2022, and is a continuation-in-part of U.S. Ser. No. 16/610,973, filed Nov. 5, 2019, which claimed priority to PCT/US2017/059892, filed Nov. 3, 2017, which in turn claimed priority to U.S. Ser. No. 15/588,630 (now U.S. Pat. No. 10,222,252), filed May 6, 2017, which in turn claimed priority to U.S. Ser. No. 62/333,015, filed May 6, 2016.

### BACKGROUND

This disclosure relates to gas flow measurement equipment and, in particular, to equipment, systems, and methods designed to improve the accuracy of gas flow measurement used in custody transfer transactions along a gas pipeline as well as lower pressure commercial and residential gas flow meters

Natural gas transmission pipelines, like those used in interstate transmission, are typically 6 inches or larger in diameter. Connected to these pipelines are in-field gas flow meter runs. These runs may include an ultrasonic gas flow meter that is used to measure the transfer of gas flowing along these lines between pipeline companies. Other runs may include a turbine or orifice meter. Regardless of the type of meter, the meter's accuracy may erode over time.

Because of the tremendous volume of gas being transferred between pipeline companies, small measurement errors can have very large financial effects. Therefore, in-field gas flow meters used in gas pipelines should be calibrated from time-to-time. However, doing this calibration requires shutting down flow through the pipeline, removing the meter run from the line, see FIG. 1, and sending the meter run to a calibration laboratory that makes use of a reference bank of meters. See FIG. 1. Additionally, as persons of ordinary skill would know, the meter is calibrated for the specific piping geometry of the run and there must be sufficient length ahead of and behind the meter in the run for accurate measurement of flow through the meter (e.g. AGA-9). These piping geometries differ from one run to the next, even on the same main pipeline.

Until the calibrated field meter run is returned from the laboratory, which is typically a week or more, and reinstalled in the line, no gas is flowing through the line. The cost and lost revenue associated with this shutdown prevents many pipeline owners from calibrating the meter as often as it should be calibrated.

Commercial building and residential home gas flow meters experience significantly lower volumes and pressures than gas transmission pipelines. For example, normal residential gas meter capacity is about 500 scfh (based upon 2″ water column differential across the meter). Normal delivery pressure is about 7″ water column (0.25 psi). Normal gas service piping from the main to the residential customer meter set is typically ½ inch or ¾ inch polyethylene. Commercial or industrial meters typically have higher flow requirements and pressures than residential. Flow requirements may be in a range of 600 scfh to over 100,000 scfh. Requirements for delivery pressure may vary from 7″ water column (0.25 psi) to distribution pressure (40-60 psi). Regardless of the volume or pressure meter accuracy remains important and may erode over time.

Current verification systems use air to test the meters. The meters are typically found in close proximity to the building or home being supplied with natural gas and access to the meter requires entering the property on which the building or house is sited. The meter is taken off line and mounted in a test unit that blows air through the meter at about 10% of meter capacity. Testing may be accurate within a range of 1% to 1.5%. However, because natural gas is not flowed through the meter, the accuracy is for measuring air.

### SUMMARY

Embodiments of a portable verification system can move from one in-field gas flow meter location to another in-field gas flow meter location and temporarily connect downstream of a main pipeline's meter run or station. A same volume of gas that passes through the field meter also passes through a calibrated ultrasonic gas flow meter (the reference meter) of the portable verification system before the volume of gas reenters the main pipeline. A control valve of the portable verification system allows volume measurement at different flow velocities to be verified. The volume of gas measured by the field meter is then compared with that of the portable verification system's calibrated meter. The field meter or its data can then be adjusted as needed.

In some embodiments, the portable verification system is connected to the meter run and the main pipeline by linearly adjustable pipeline sections. These sections can be arranged to extend horizontally and vertically, as well as swivel to provide versatility when connecting in the field. Adaptor fittings having one flange sized for and fitted to the inlet and outlet ends of the portable verification system and another flange sized for the meter run or main pipeline connection provide additional versatility.

After the field meter is verified to a desired level of accuracy, the portable verification system can be disconnected and the meter run reconnected to the main pipeline for usual flow from the run to the pipeline. The portable verification system can then be transported to another field location. If a decision is made to send the field meter to a calibration lab for calibration, the portable verification system can remain in place until the newly calibrated field meter is returned and reinstalled in the meter run.

Embodiments of a portable verification system of this disclosure are moveable between, and connectable to, a first in-field gas flow meter run having a first piping geometry and a second different in-field gas flow meter run having a second different piping geometry; said meter runs located at and connected to, respectively, a first main pipeline section at a first field location and a second different main pipeline section at a second different field location; the first in-field gas flow meter run including a first in-field gas flow meter previously calibrated for use with the first piping geometry and the second different in-field gas flow meter run including a second gas flow meter previously calibrated for use with the second different piping geometry; the portable verification system including a wheeled trailer; a reference meter run having a third different piping geometry mounted on the wheeled trailer and independent of that of the first and second different piping geometries and including a single meter tube; an ultrasonic gas flow meter contained by the single meter tube and calibrated for use with the third different piping geometry; and a field adjustable piping section having a fourth different geometry; the third different piping geometry further including an inlet piping of effective length for use in ultrasonic gas flow measurement and connected at one end to an inlet end of the single meter tube; an outlet piping of effective length for use in ultrasonic gas flow measurement and connected at one end to an outlet end of the single meter tube; the fourth different piping geometry including an adjustable inlet piping connectable at one end to the inlet piping of the mobile reference meter run and at another end to a downstream end of a respective field meter run of the first and second in-field gas flow meter runs; and an adjustable outlet piping connectable at one end to the outlet piping of the mobile reference meter run and at another end to a respective main pipeline section of the first and second different main pipeline sections; the adjustable inlet and outlet piping configured for adjustment in horizontal length, vertical height, and clock position relative to a horizontal plane, said adjustment not affecting a gas flow measurement of the ultrasonic gas flow meter of the reference meter run.

Embodiments of a method of verifying a first in-field gas flow meter when connected to a first main pipeline section transporting natural gas include completing a circuit between the first in-field gas flow meter run, a portable verification system, and the first main pipeline section; permitting the natural gas to flow from the first main pipeline section through the first in-field gas flow meter run and into and through the portable verification system and back into the first main pipeline section; and measuring an amount of natural gas flowing through the first in-field gas flow meter run and through the portable verification system; wherein the first in-field gas flow meter is connected to the first main pipeline section by a first in-field gas flow meter run having a first piping geometry, the first in-field gas flow meter previously calibrated for use with the first piping geometry; and wherein the portable verification system includes a reference meter run having a third different piping geometry, an ultrasonic gas flow meter contained by a single meter tube and calibrated for use with the third different piping geometry, and a field adjustable piping section having a fourth different piping geometry; and wherein the completing the circuit includes adjusting the field adjustable section, the field adjustable section when in a connected state not affecting a gas flow measurement of the ultrasonic gas flow meter of the reference meter run. The portable verification system may then be disconnected, moved, and connected to a second in-field gas flow meter connected to a second different main pipeline section transporting natural gas, the second in-field gas flow meter connected to the second different main pipeline section by a second different in-field gas flow meter run having a second different piping geometry, the second different in-field gas flow meter previously calibrated for use with the second different piping geometry.

Embodiments of a portable verification system for use in verifying commercial building and residential home gas flow meters includes a wheeled cart containing a piping circuit having a calibrated ultrasonic (master) meter and an air blower in fluid communication with the ultrasonic meter. The master meter may include a flow conditioner. Flexible hoses connect the inlet and outlet of the piping circuit to the commercial building or residential home gas flow meter (field meter) where it can be tested in situ using natural gas. The piping circuit includes valves for controlling flow through the piping circuit. An uninterruptable power supply (e.g. battery) and generator located on the wheeled cart provide required power. The generator may be a 2500 W generator for outdoor use.

### BRIEF DESCRIPTION OF THE DRAWINGS

FIG. 1 is a schematic of a prior art field meter run connected to a main pipeline. When the in-field gas flow meter of the run requires calibration or verification, the main pipeline must be shut down to remove the field meter and remain shut down until the meter is returned from a calibration lab and reinstalled with its piping geometry.

FIG. 2 is a schematic of an embodiment of portable verification system when connected to a downstream end of the field meter run. Gas flows through the field meter run and through a calibrated ultrasonic gas flow meter of the portable verification system before returning to the main pipeline. The main pipeline is shut down only for the amount of time required to complete a circuit between the field meter run, the portable verification system, and the main pipeline.

FIGS. 3A and 3B are a schematic of an embodiment of a portable verification system that includes a linearly adjustable pipeline section (see FIG. 3A) connecting the system to a field meter run of a main pipeline (see FIG. 3B). The adjustable pipeline section may be arranged to extend horizontally as well as vertically to make a connection between the portable verification system and a corresponding connection point of the field meter run or main pipeline.

FIG. 4 is an embodiment of a slip joint adaptor that may be used to seal the linearly extendable pipeline section of FIG. 3.

FIG. 5 is an enlarged view of the slip joint adaptor of FIG. 4.

FIG. 6 is a front elevation view of an embodiment of an adaptor fitting that may be used to connect the inlet or outlet end to a corresponding outlet or inlet flange of the meter run or main pipeline, respectively.

FIG. 7 is a front elevation view of another embodiment of an adaptor fitting. In embodiments, the flange on the meter run or main pipeline side of the fitting may vary from one adaptor to the next with the flange on the portable verification side of the fitting being the same across the different adaptor fittings.

FIG. 8 is a schematic of an embodiment of a quick disconnect to minimize connect and disconnect time of a field meter run.

FIG. 9 is an isometric view of an embodiment of an air spring arrangement used to connect the reference meter run piping to a trailer.

FIG. 10 is a schematic of an embodiment of a portable verification system for use in verifying commercial building and residential home gas meters. Natural gas flows through the field meter, into the portable verification system, and into the commercial building or residential home. In embodiments, the ultrasonic gas flow meter of the portable verification system may be one that includes both the meter and a volume corrector, such as a FLOWSIC500™ ultrasonic compact gas flow meter or its equivalent.

FIG. 11A is a front elevation view of a flexible stainless double wall hose used in connection with the piping circuit of FIG. 10 and having a lap joint flange at one end and a raised face weld neck flange at the other end.

FIG. 11B is a front elevation view of connection adaptor using in connection with the piping circuit of FIG. 10. Size may range from 1.5″ ANSI 150 to 6″ ANSI 150.

### ELEMENTS AND NUMBERING USED IN THE DRAWINGS AND DETAILED DESCRIPTION

5 Portable verification system or mobile reference meter system

10 Pipe or piping

10_{I} or 10i Inlet piping

10_{O} or 10o Outlet piping

11 Inlet end

12 Meter tube

13 Reference measurement section or meter run

14 Inlet end of 12

15 Calibrated ultrasonic gas flow meter (reference meter)

16 Outlet end of 12

17 Turn

19 Control valve

21 Outlet end

23 Measurement trailer

30 First slip or linear adjustable pipeline section (horizontal)

31 End (inlet or outlet depending on direction of flow)

33 Outer pipe

35 End

37 Inner pipe

41 End (inlet or outlet depending on direction of flow)

43 Lift eye

45 Elbow

47 Lift eye

49 Lap joint flange

50 Sealing means

51 Slip joint or slip joint adaptor

53 Packing gland

55 Head

57 Pocket

59 O-ring

61 Spacer

63 Follower or pusher

70 Second slip linear adjustable pipeline section (vertical)

90 Adaptor

91 Flange

93 First end

95 Bolt hole pattern

97 Flange

99 Second end

101 Bolt hole pattern

130 Pneumatic suspension devices or air springs

M In-field meter (meter under test)

205 Portable verification system or mobile reference meter system

210 Pipe or piping

210i Inlet piping

210o Outlet piping

211 Inlet end

215 Calibrated ultrasonic gas flow meter (reference or master meter)

217 Turn

219 Flow control valve

221 Outlet end

223 Measurement trailer or wheeled cart

225 Air blower

230 Flexible hose

231 Tee

233 First end

235 Second end

237 Third end

249 Lap joint flange

290 Adaptor

291 Flange

293 Battery power and generator

### DETAILED DESCRIPTION

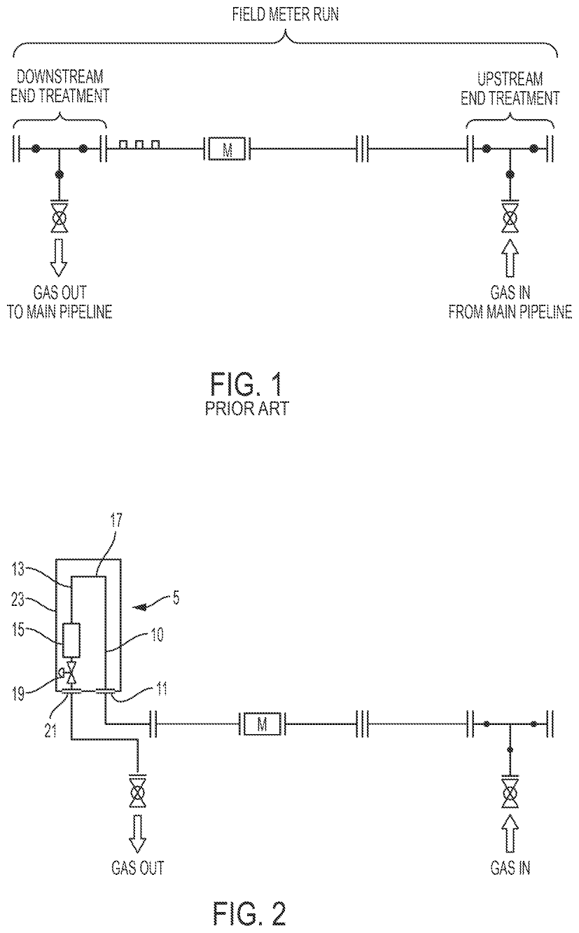

Referring now to FIG. 2, in embodiments of a portable verification system 5 a reference measurement section or meter run 13 is trailered to a main pipeline transporting gas and connected downstream of the main pipeline's meter run or station. In some embodiments, the portable verification system 5 is mounted on a measurement trailer 23. The trailer 23 may be no wider than a standard flatbed trailer (about 102″ in width). The amount of downtime experienced by the main pipeline is limited to the amount of time needed to complete a circuit between a downstream end of the field meter run, the portable verification system 5, and the main pipeline. In some embodiments, this circuit can be completed in less than 12 hours, less than 10 hours, or less than 8 hours. Disconnection of the system 5 and reconnection of the field meter run to the main pipeline may be accomplished in similar time frames.

The reference meter run 13 includes an inlet piping run 10_{I} having an inlet end 11 connectable to an end treatment of the field meter run, an outlet piping run 10O having an outlet end 21 connectable to a flanged connection fitting of the main pipeline, and a calibrated ultrasonic gas flow meter (the reference meter) 15 located between the inlet end and outlet ends 11, 21. Gas flowing through the field meter M enters the portable verification system 5 and flows through the calibrated ultrasonic flow meter 15 of the reference meter run 13. The gas then flows back into the main pipeline. The meter 15 may be contained in a meter tube 12 of a kind known in the art having one flanged end 14 connected to the inlet piping 10_{I} of the run 13 and another flanged end 16 connected to the outlet piping 10_{O}.

As persons of ordinary skill in the art would recognize, the meter 15 must be calibrated for use with the piping geometry of the run 13 and the length of the piping 10 ahead of and behind the meter 15 must be of effective length relative for use in ultrasonic gas flow measurement. The effective length is typically a function of the pipe diameter. The reference meter run 13 may include a piping geometry having at least one turn 17 between the ends 11, 21 and can be arranged in some embodiments as a U-shaped or C-shaped run. In embodiments, the reference meter run 13 also may include a flow conditioner located ahead of the meter 15. The run 13 may also include means to attenuate ultrasonic waves and prevent their return toward, and interference with, the meter 15. Those means include elbows and blind flanges.

The pipe 10 used in the portable verification system 5 can be the same diameter as that of the main pipeline's meter run. For example, if the field meter run uses 12-inch pipe, system 5 can use 12-inch pipe. In other embodiments, a different size (larger or smaller) pipe. Where different size pipe is used, appropriate adjustments are made to equate the volume of gas flowing per unit time through the field meter M with that flowing through the calibrated ultrasonic gas flow meter 15. In other words, the calibrated reference meter 15 experiences the same volume of gas the field meter M experiences at either the same velocity as the field meter M or at a proportional velocity. Because the meter 15 is located downstream of the field meter M, the flow through the field meter M is an unadulterated flow, unaffected by the presence of the portable verification system 5. Additionally, because the reference meter run 13 is a known piping geometry, the reference meter 15 is unaffected by connections to the field meter run which has different piping geometry than that of the reference meter run 13. Because the distance to, relative height between, and clock position of the trailer 15 to the field meter run and main pipeline will differ from field location to field location, the connections should be adjustable in length, height, and clock position (relative to a horizontal plane).

A control valve 19 may be installed downstream of the calibrated ultrasonic gas flow meter 15, such as between the meter 15 and the outlet end 21, to restrict flow through the valve 19 and drop flow velocity through the field meter M by way of backpressure. For example, if the flow is 55 fps through the field meter M, flow can be restricted through the valve 19 to drop the flow to rates below 55 fps and at or above 5 fps. Depending on whether size-on-size piping is used, the calibrated ultrasonic flow meter 15 experiences the same or a proportional velocity through it. In some embodiments, at least three different flow rates are selected, with corresponding volume measurement data provided for verification purposes.

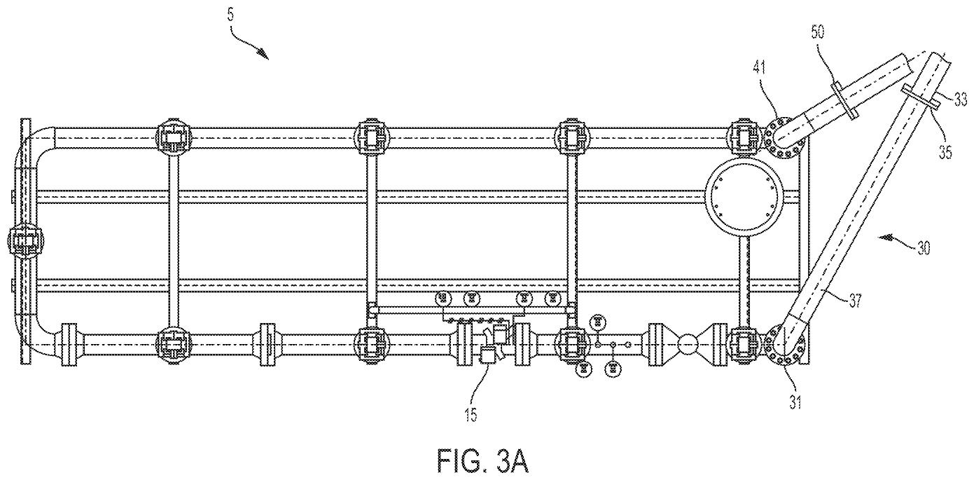

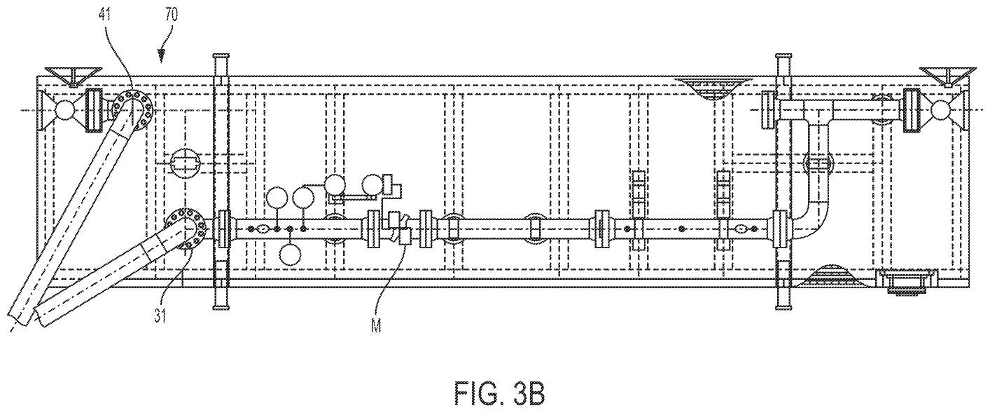

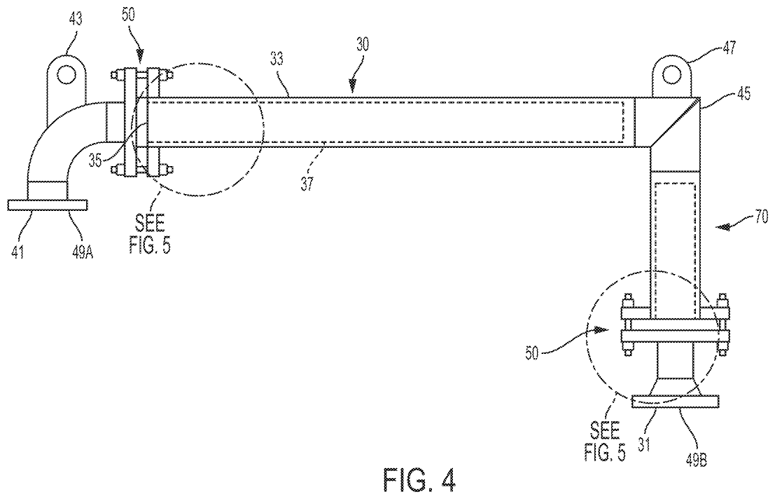

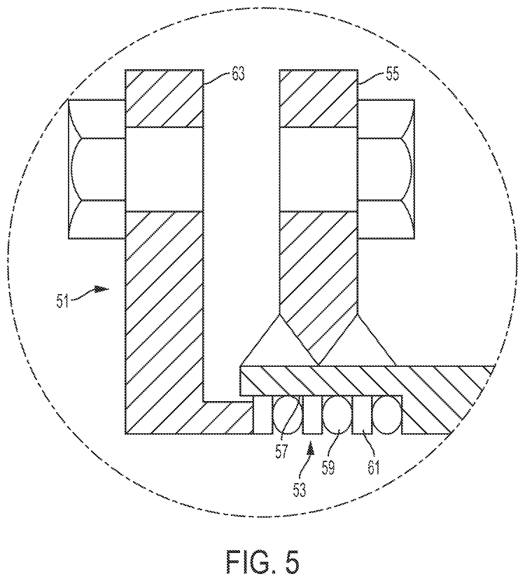

As previously mentioned, additional piping geometry may be used to connect the inlet and outlet piping 10_{I}, 10O of the reference meter run 13 to the field meter run and main pipeline. This inlet and outlet piping may be configured for adjustment in horizontal length, vertical height, and clock position relative to a horizontal plane, the adjustment not affecting a gas flow measurement of the ultrasonic gas flow meter 15 of the reference meter run 13. Referring now to FIGS. 3 to 5, in some embodiments, at least one of the inlet and outlet ends 11, 21 includes at least one slip or linearly adjustable pipeline section 30 or 70 spanning between it and a corresponding connection point of the field meter run or main pipeline. The first linearly adjustable pipeline section 30 may be arranged to extend horizontally. For example, the linearly adjustable pipeline section 30 may extend in overall length in a range of about 10 to 25 feet. The second linearly adjustable pipeline section 70 may be arranged to extend vertically. For example, the linearly adjustable pipeline section 70 may extend in a range of 4 to 7 or 8 feet, permitting one section 30 to cross over another section 30. When used in combination, the sections 30 and 70 may be connected by an elbow 45 having a lift eye 47. The linearly adjustable pipeline section 70 may also be used to swivel or orient section 30 into a desired clock position or angular orientation relative to a horizontal plane.

The linearly adjustable pipeline sections 30, 70 can include an outer pipe 33, an inner pipe 37 housed by and extendable from the outer pipe 33, and means to seal 50 an end 35 of the outer pipe 33 about the inner pipe 37. The inlet or outlet ends 31, 41 of the section 30, 70 may include a lap joint flange 49A, 49B for connection to a corresponding inlet or outlet end 11, 21 of the portable verification system 5 or to the field meter run or main pipeline. In some embodiments, one end 31, 41 is an elbow and the other end 41, 31 is straight. A lift eye 43 may be added to the inlet or outlet end 31, 41.

The means to seal 50 the outer pipe 33 about the inner pipe 37 may be a slip joint 51 that includes a packing gland 53 arranged in a pocket 57 located between a head 55 and follower or pusher 63. In some embodiments, the packing gland 53 includes at least two O-rings 59 with a moveable spacer 61 located in between. As the pusher 63 is drawn toward the head 55, the O-rings 59 become compressed between the head 55 and spacer 61, and between the spacer 61 and pusher 63, and therefore expand into sealing engagement with pipe 37.

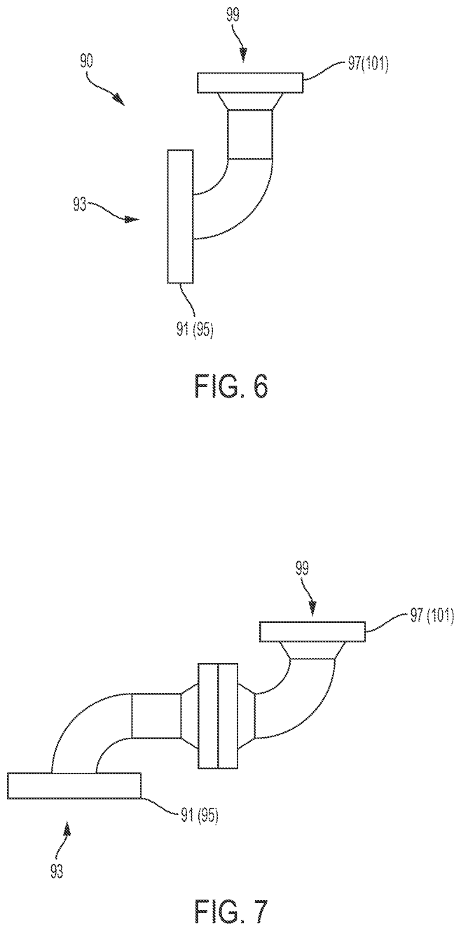

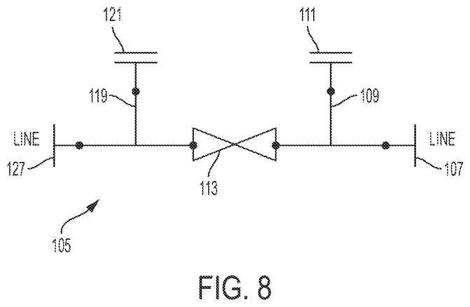

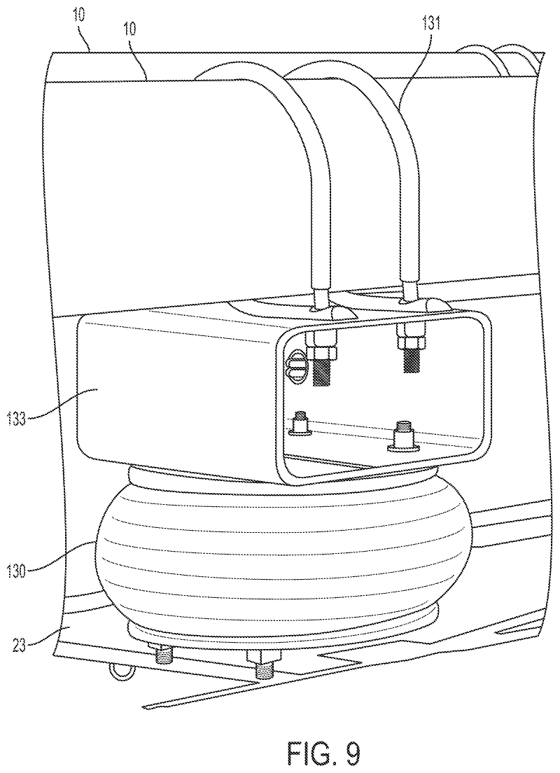

Referring now to FIGS. 6 & 7, because of differences in connection flanges used on meter runs and main pipelines, the portable verification system 5 may also use at least one adaptor fitting 90. In embodiments, adaptor fitting 90 is connectable to the inlet or outlet ends 11, 21 of the portable verification system 5 or to the inlet or outlet ends 31, 41 of the linear adjustable pipeline sections 30, 70. The adaptor fitting 90 may have a first flange 91 at one end 93 having a first bolt hole pattern 95 and a second flange 97 at another end 99 having a second bolt hole pattern 101. The first and second flanges 91, 97 may differ from one another in bolt hole pattern 95, 101 , diameter, or bolt hole pattern 95, 101 and diameter.

The first flange 91 may be adapted for connection to the inlet or outlet end 11, 21 (or 31, 41) of system 5, with the second flange 97 adapted for connection to the field meter run or main pipeline side. In other words, first flange 91 can be standard among adaptor fittings 90 but second flange 97 differs. In this way, the portable verification system 5 may be connected to a wide variety of different end treatment and main pipeline flange connections by simply changing the adaptor fitting 90.

Embodiments of a method of verifying a field ultrasonic gas flow meter when connected to a main pipeline transporting a gas include completing a circuit between the measurement section, the portable verification system 5, and the main pipeline; allowing a gas to flow through the field meter M and then through a calibrated ultrasonic gas flow meter 15 of the portable verification system 5; and comparing a volume of gas measured by the two meters M, 15.

Completing the circuit may include extending a first or a second linearly adjustable pipeline section 30, 70 (or both) from at least one of the inlet and outlet ends 11, 21. The method may also include changing a direction of the horizontal linearly adjustable pipeline section 30, for example, by swiveling the vertical linearly adjustable pipeline section 70 into a desired clock position or angle relative to a horizontal plane. Section 70 may be used vertically extend from the inlet or outlet ends 11, 21. The method may also include connecting an adaptor fitting 90 between at least one of the inlet end 11 and the downstream end of the measurement section or between the outlet end 21 and the main pipeline. An adaptor fitting 90 may also be used at the inlet or outlet ends 31, 41 of the linear adjustable pipeline sections 30, 70. After testing in the field, the reference meter run 13 may be disconnected from the field meter run and main pipeline section and moved to a different location to test a different field meter of a different field meter run and main pipeline section. The reference meter run 13 may also be left in place temporarily if the field meter and its run is sent to a calibration lab.

The method may also include changing a velocity of the volume of gas flowing through the portable verification system 5 (and therefore through the field meter M) between a first velocity and a second different velocity. The first velocity may be the field velocity. The second different velocity may be a velocity above or below the field velocity. Changing the velocity may be done by way of adjusting a flow control valve 19 located between the calibrated ultrasonic gas flow meter 15 and the outlet end 21 of the portable verification system 5.

As shown in FIGS. 3A & B, a plurality of pneumatic suspension devices or air springs 130 may be located between portions of piping 10 of the reference meter run 13 and the measurement trailer 23. Truck or trailer application air springs are a suitable air spring 130. The air springs 130 “float” the piping 10 above the trailer 23 and provide shock absorption, positioning adjustment of the rigid piping 10 relative to the trailer 23, and height adjustment of the piping 10. For example, one portion of the piping 10 may be lowered and another raised. The air springs 130 may be in communication with a pneumatic control system (not shown) to lower or raise the height of the air springs 130.

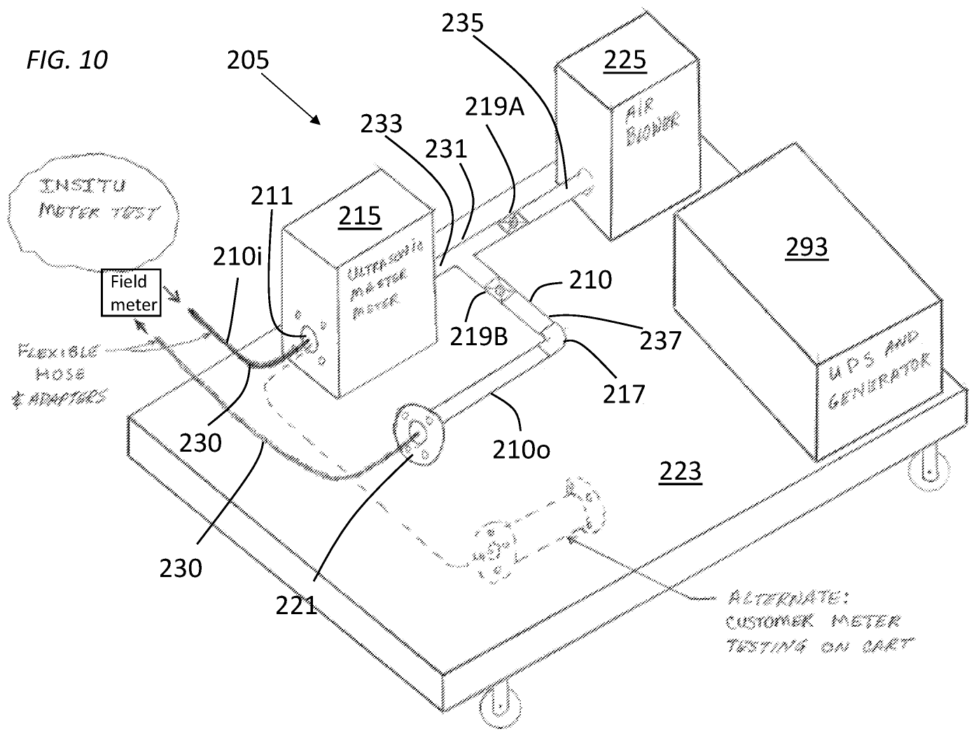

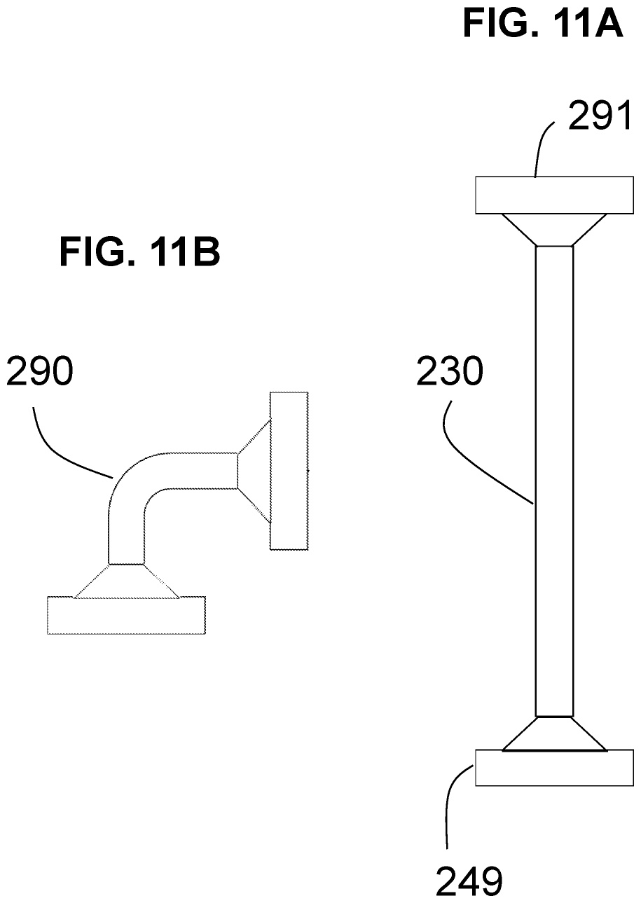

Referring now to FIGS. 10, 11A and 11B, a portable verification system 205 arranged for use in commercial or industrial building and residential home settings includes a wheeled cart 223 and, mounted on the wheeled cart 223:
a piping circuit 210 including an inlet end 211, an outlet end 221, and, between the inlet and outlet ends 211, 221, two flow control valves 219A and B and one tee 231;
an ultrasonic gas flow meter 215 located between the inlet end 211 of the piping circuit 210 and a first end 233 of the tee;
an air blower 225 located at a second end 235 of the tee 231; and
a battery and a generator 293, the battery in circuit relation to the generator, the ultrasonic gas flow meter 215, and the air blower 225;
   One valve 219A of the two flow control valves 219 is located between the first and second ends 233, 235 of the tee 231 and therefore between the ultrasonic gas flow meter 215 and the air blower 225. Another valve 219B of the two flow control valves 219 is located toward a third end 237 of the tee 231 and therefore toward the outlet end 221 of the piping circuit 210.

The piping circuit 210 further includes two flexible hoses 230. Each flexible hose 230 includes a flange 291 at one end and a lap joint flange 249 at another end, the flange 291 connected to a corresponding one of the inlet and outlet ends 211, 221 of the piping circuit 210. Note that in embodiments, the inlet end 211 may be a run of pipe similar to that shown on the outlet end 221 or flange 291 may mount directly to the ultrasonic gas flow meter 215.

When in an intended use, a same natural gas flow flows through the gas meter M connected to the commercial or industrial building or residential home and the portable verification system 205. In some embodiments, the natural gas first flows into the gas flow meter M of the building and then into the ultrasonic gas flow meter 215 of the portable verification system 205. In other embodiments, the natural gas first flows into the ultrasonic gas flow meter 215 of the portable verification system 205 and then into the gas flow meter M of the building.

Control valve 219A is in a closed position to prevent gas flow to the air blower 225. The natural gas then exits the outlet end 221 and enters the piping circuit of the building or home. The results of the field meter M and reference meter 215 may then be compared.

In some embodiments, the field meter may also be tested on the wheeled cart 223 with the reference meter 215 removed or bypassed. The air blower 225 may be used for the test with control valves 219A and 219B both open. The air blower 225 may be a centrifugal blower sized to test the field meter at a predetermined percentage of capacity. In some embodiments, the predetermined percentage is 10%, 10% to 20%, 20% to 30%, 30% to 40% and so on up to 90% to 100%.

In embodiments, the difference in the measured volumes can be reported. The measured volume of the gas flow meter may then be adjusted or corrected by the difference or by a bias factor or percentage based upon the difference.

The embodiments that have been described here provide illustrative examples. The disclosure extends to all functionally equivalent structures, methods, and uses that fall within the scope of the following claims.

What is claimed:

1. A portable verification system comprising:
a wheeled cart and, mounted on the wheeled cart:
a piping circuit including an inlet end, an outlet end, and, between the inlet and outlet ends, two flow control valves and one tee;
an ultrasonic gas flow meter located between the inlet end of the piping circuit and a first end of the tee;
an air blower located at a second end of the tee; and
a battery and a generator, the battery in circuit relation to the generator, the ultrasonic gas flow meter, and the air blower;
wherein, one of the two flow control valves is located between the first and second ends of the tee and therefore between the ultrasonic gas flow meter and the air blower, another of the two flow control valves is located toward a third end of the tee and therefore toward the outlet end of the piping circuit;
the piping circuit further including two flexible hoses, each flexible house including a flange at one end and a lap joint flange at another end, the flange connected to a corresponding one of the inlet and outlet ends of the piping circuit.

2. A method for verifying a gas flow meter arranged to measure use of natural gas when the gas flow meter is connected to a natural gas piping system of a building, the method comprising:
shutting off a supply of the natural gas to the natural gas piping system;
after the shutting off, connecting the portable verification system to the supply in order to place the portable verification system in flow relationship with the supply, the gas flow meter, and the natural gas piping system;
after the connecting, turning on the natural gas supply; and
after the turning on, flowing the natural gas into an ultrasonic gas flow meter of the portable verification system and the gas flow meter; and
comparing a volume of the natural gas measured by the ultrasonic gas flow meter of the portable verification system and the natural gas as indicated by the gas flow meter;
wherein the portable verification system includes:
a wheeled cart and, mounted on the wheeled cart:
a piping circuit including the inlet end, the outlet end, and, between the inlet and outlet ends, two flow control valves and one tee;
an ultrasonic gas flow meter located between the inlet end of the piping circuit and a first end of the tee;
an air blower located at a second end of the tee; and
a battery and a generator, the battery in circuit relation to the generator, the ultrasonic gas flow meter, and the air blower;
wherein, one of the two flow control valves is located between the first and second ends of the tee and therefore between the ultrasonic gas flow meter and the air blower, another of the two flow control valves is located toward a third end of the tee and therefore toward the outlet end of the piping circuit;
the piping circuit further including two flexible hoses, each flexible house including a flange at one end and a lap joint flange at another end, the flange connected to a corresponding one of the inlet and outlet ends of the piping circuit.

3. The method of claim 2, wherein, the flowing is first into the gas flow meter of the building and then into the ultrasonic gas flow meter of the portable verification system.

4. The method of claim 2, wherein, the flowing is first into the ultrasonic gas flow meter of the portable verification system and then into the gas flow meter of the building.

5. The method of claim 2, further comprising, after the comparing, reporting a difference in the volume of the natural gas measured by the ultrasonic gas flow meter of the portable verification system and by the gas flow meter of the building.

6. The method of claim 3, further comprising, adjusting a measured volume of the gas flow meter measured by the difference.
